(19) United States
(12) Patent Application Publication
(10) Pub. No.: US 2016/0187701 A1
(43) Pub. Date: Jun. 30, 2016

(54) SUPPORT STRUCTURE OF DISPLAY PANEL AND DISPLAY PANEL

(71) Applicant: SHENZHEN CHINA STAR OPTOELECTRONICS TECHNOLOGY CO., LTD., Guangdong (CN)

(72) Inventor: Hua ZHENG, Shenzhen (CN)

(73) Assignee: Shenzen China Star Optoelectronics Technology Co., Ltd., Guangdong (CN)

(21) Appl. No.: 14/417,416

(22) PCT Filed: Dec. 9, 2014
(86) PCT No.: PCT/CN2014/093386

§ 371 Date: Mar. 7, 2016

(30) Foreign Application Priority Data
Jun. 24, 2014 (CN) 201410290750.7

(51) Int. Cl. G02F 1/1339; G02F 1/1333; G02F 1/1335

(52) U.S. Cl. CPC G02F 1/13394; G02F 1/133514; G02F 1/133345; G02F 1/133512

(57) ABSTRACT

The field of display technologies is related, and a support structure of a display panel and a corresponding display panel are provided. The support structure comprises an array substrate, a color filter substrate, and a photo spacer that is arranged between the array substrate and the color filter substrate and extends along a first direction. The photo spacer has a first end portion fixed to the color filter substrate. The array substrate has a lower plate glass with at least two functional layers at a side of the lower plate glass facing the color filter substrate, the at least two functional layers of the array substrate having openings.

### CROSS-REFERENCE TO RELATED APPLICATIONS

The present application claims benefit of Chinese patent application CN 201410290750.7, entitled “Support structure of display panel and display panel” and filed on Jun. 24, 2014, the entirety of which is incorporated herein by reference.

### FIELD OF THE INVENTION

The present disclosure relates to the field of display technologies, and in particular, to a support structure of a display panel and a corresponding display panel.

### BACKGROUND OF THE INVENTION

In liquid crystal display (LCD) panels, a photo spacer (PS) is commonly used to maintain a spacing distance between an array substrate and a color filter substrate.

FIG. 1 shows a support structure 100 of a display panel in the prior art. The support structure 100 indicates the structure of a typical photo spacer. As shown in FIG. 1, the support structure 100 comprises a color filter substrate and an array substrate. The color filter substrate includes an upper plate glass 10, a black matrix (BM) layer 1, and an indium tin oxide (ITO) layer 2. A photo spacer 3 is arranged on the color filter substrate. Generally, the photo spacer 3 can be formed on a base of the BM layer 1 and that of the ITO layer 2. Of course, in theory, the photo spacer 3 can be formed directly on the upper plate glass 10 also. A free end of the photo spacer 3, i.e., a lower end as shown in FIG. 1, abuts against a lower plate glass 20 of the array substrate. In this manner, the photo spacer 3 functions as maintaining a spacing distance between the array substrate and the color filter substrate.

FIG. 2 shows another support structure 200 of a display panel in the prior art. The support structure 200 indicates the structure of a typical photo spacer. As shown in FIG. 2, the support structure 200 comprises a color filter substrate and an array substrate. The color filter substrate comprises an upper plate glass 10, a black matrix (BM) layer 1, and an indium tin oxide (ITO) layer 2. A photo spacer 3 is arranged on the color filter substrate. Generally, the photo spacer 3 can be formed on a base of the BM layer 1 and that of the ITO layer 2. Of course, in theory, the photo spacer 3 can be directly formed on the upper plate glass 10 also. The array substrate comprises a lower plate glass 20 and a functional layer 4 arranged on a side of the lower plate glass 20 facing the color filter substrate. The functional layer 4 can, for example, be a first metal layer. A free end of the photo spacer 3, i.e., a lower end as shown in FIG. 2, abuts against the functional layer 4 of the array substrate. In the embodiment as shown in FIG. 2, the functional layer 4 constitutes the first metal layer. In this manner, the photo spacer 3 functions as maintaining a spacing distance between the array substrate and the color filter substrate.

A display panel using the support structure in the prior art as illustrated above has the following defects. When the display panel deforms under impact of an external force, the color filter substrate and the array substrate would be subject to horizontal dislocation with respect to each other in the plane where the display panel is located, i.e., the lateral direction as shown in FIGS. 1 and 2. Moreover, automatic recovery thereof would be impossible. Such horizontal dislocation of the array substrate and the color filter substrate with respect to each other would lead to light leakage from the panel, thus causing the problems of inhomogeneous display colors, image interference, etc. As a result, the quality of the display panel would be severely deteriorated.

### SUMMARY OF THE INVENTION

As discussed above, in the prior art, a photo spacer is designed in such a manner that it might lead to a horizontal dislocation of a color filter substrate and an array substrate with respect to each other in the plane where the display panel is located.

Moreover, automatic recovery of the dislocation would hardly be possible. Such horizontal dislocation of the array substrate and the color filter substrate with respect to each other would result in light leakage from the panel, thus causing the problems of inhomogeneous display colors, image interference, etc. As a result, the quality of the display panel would be severely deteriorated.

To solve the above problems, the present disclosure provides a support structure of a display panel, comprising an array substrate, a color filter substrate, and a photo spacer that is arranged between the array substrate and the color filter substrate and extends along a first direction, for maintaining a distance between the array substrate and the color filter substrate. The array substrate has a lower plate glass with at least two functional layers at a side of the lower plate glass facing the color filter substrate, the at least two functional layers of the array substrate having openings, which, viewed from the first direction, at least partially overlap with each other to jointly constitute a recess through which the photo spacer passes, at least a part of the recess being tapered toward the lower plate glass in size along a second direction. The photo spacer has a first end portion fixed to the color filter substrate, and passes through the recess to abut against the lower plate glass or against one of the functional layers at a second end portion of the photo spacer. The first direction constitutes a normal direction of the display panel, and the second direction is in the plane where the display panel is located.

Compared with the prior art, the support structure of a display panel according to the present disclosure can remove the aforementioned technical defects and bring about new advantages.

At the outset, according to the support structure of a display panel of the present disclosure, a recess through which the photo spacer passes is formed on the array substrate. Such being the case, a side wall of the recess would prevent slide of the photo spacer along the second direction, thereby fixing the photo spacer in the plane where the panel is located. As can be seen, the recess functions as limiting the color filter substrate and the array substrate with respect to each other, to avoid dislocation therebetween in the plane where the panel is located. As a result, the problems of light leakage from the panel, inhomogeneous display colors, and image interference, etc.

caused thereby can be avoided, thus improving the quality of the panel. Such improvement is impossible in the prior art.

Moreover, at least a part of the recess is tapered toward the lower plate glass in size along the second direction. In this manner, a stepped side wall having a plurality of steps can be formed in the recess. Thus, a dislocated photo spacer would slide back to its original position along the side wall under the effect of gravity. That is, the photo spacer can be restored to its original position automatically.

In addition, the stepwise tapered recess can be formed by a plurality of functional layers of the array substrate through a rather simple procedure. No additional component, clad layer, or coating layer is required. Instead, the functional layers that have already been arranged in the array substrate are ingeniously used. Hence, the above two additional effects can be achieved without increasing complexity of the procedure or sizes of a product.

Preferably, the sizes of the openings of the different functional layers of the array substrate in the second direction are reduced toward the lower plate glass gradually. In this manner, all the functional layers of the array substrate can be adequately used for preventing dislocation. Moreover, the stepped side wall of the recess that has been formed is continuously tapered in size, thus enabling an optimal effect in preventing the photo spacer from being dislocated.

Preferably, a difference between the distance from an edge of the opening of a functional layer to an outer circumferential surface of the photo spacer and the distance from an edge of the opening of an adjacent functional layer to said outer circumferential surface of the photo spacer is in the range from 0.5 μm to 10 μm. Such arrangement of the size of the stepped structure enables an optimal effect in preventing dislocation of the photo spacer.

Preferably, the array substrate comprises five functional layers, respectively as a first metal layer adjacent to the lower plate glass, a first insulation layer adjacent to the first metal layer, a second metal layer adjacent to the first insulation layer, a second insulation layer adjacent to the second metal layer, and a pixel electrode layer adjacent to the second insulation layer, wherein each of the five functional layers has an opening, and the second end portion of the photo spacer abuts against the lower plate glass. Such arrangement of the functional layers as aforementioned can particularly be combined with a commonly used procedure for manufacturing an array substrate in the prior art in a convenient manner.

Preferably, the distance from an edge of the opening of the first metal layer to the outer circumferential surface of the photo spacer is in the range from 0 μm to 10 μm. The distance from the edge of the opening of the first metal layer to the outer circumferential surface of the photo spacer would predominately influence the size of the recess. The photo spacer can be restored to its original position in an automatic and rapid manner under the function of a gradient of the recess if a dislocation occurs, when the above size range is satisfied.

Preferably, the array substrate comprises six functional layers, respectively as a first metal layer adjacent to the lower plate glass, a first insulation layer adjacent to the first metal layer, an amorphous silicon layer adjacent to the first insulation layer, a second metal layer adjacent to the amorphous silicon layer, a second insulation layer adjacent to the second metal layer, and a pixel electrode layer adjacent to the second insulation layer, wherein each of the six functional layers has an opening, and the second end portion of the photo spacer abuts against the lower plate glass. This technical solution can be particularly used in an array substrate manufactured through a five mask procedure, which is commonly adopted in the manufacturing procedure of a display panel. Hence, in combination with the support structure according to the present disclosure, costs of large-scale manufacture can be beneficially reduced.

Preferably, the distance from an edge of the opening of the first metal layer to the outer circumferential surface of the photo spacer is in the range from 0 μm to 10 μm. The distance from the edge of the opening of the first metal layer to the outer circumferential surface of the photo spacer predominantly influences the size of the recess. The photo spacer can be restored to its original position in an automatic and rapid manner under the function of a gradient of the recess if a dislocation occurs, when the above size range is satisfied.

Preferably, the array substrate comprises two functional layers, respectively as a first metal layer adjacent to the lower plate glass and a first insulation layer adjacent to the first metal layer, wherein each of the two functional layers has an opening. A stepped recess formed by two functional layers, each of which has an opening, can beneficially prevent movement of the photo spacer. Moreover, in case the photo spacer moves, it can be restored to its original position. According to the present disclosure, an additional functional layer will be unnecessary. The present embodiment can be employed where the costs of the procedure and materials are the primary consideration. As a result, not only the technical problems as mentioned above can be removed, but the costs of time and funds can be maximally reduced.

Preferably, the array substrate comprises a first metal layer adjacent to the lower plate glass, the first metal layer having no opening, and four functional layers, respectively as a first insulation layer adjacent to the first metal layer, a second metal layer adjacent to the first insulation layer, a second insulation layer adjacent to the second metal layer, and a pixel electrode layer adjacent to the second insulation layer, wherein each of said four functional layers has an opening, and the second end portion of the photo spacer abuts against the first metal layer. In this embodiment, the first metal layer can be provided with no opening.

Preferably, the color filter substrate has an upper plate glass, and a black matrix and a common electrode that are both located on the upper plate glass on a side thereof facing the array substrate. The first end portion of the photo spacer is fixed to the upper plate glass on a surface thereof facing the array substrate, or to the black matrix on a surface thereof facing the array substrate, or to the common electrode layer on a surface thereof facing the array substrate. The technical solution according to the present disclosure allows a plurality of alternatives and is sufficiently flexible.

The present disclosure further provides a display panel, which comprises the support structure of a display panel according to the present disclosure.

The support structure of a display panel and the display panel according to the present disclosure provide an effective solution to the problem of easy occurrence of dislocation between the color filter substrate and the array substrate in the prior art. In the present disclosure, the functional layers that have already been arranged in the array substrate are skillfully used to form a recess which has a plurality of steps and is tapered downwardly in size in a stepped manner. The side wall of the recess can be used to limit movement of the photo spacer in the plane where the panel is located. Meanwhile, even if the photo spacer is dislocated due to movement thereof, and slides to a functional layer located in an upper position thereof, it can automatically slide back to its original position due to the step-structured side wall of the recess under the effect of, for example, gravity, thereby removing the dislocation of the array substrate and the color filter substrate with respect to each other. As a result, the defects of light leakage, inhomogeneous light, and image interference, etc. caused thereby can be completely eliminated.

The above technical features can be combined in any appropriate manner or be substituted by any equivalent technical features, so long as the purpose of the present disclosure can be achieved.

### BRIEF DESCRIPTION OF THE DRAWINGS

The present disclosure will be explained in more detail with reference to embodiments and accompanying drawings, in which:

FIG. 1 shows a support structure of a display panel in the prior art;

FIG. 2 shows another support structure of a display panel in the prior art;

FIG. 3 shows a first embodiment of a support structure of a display panel according to the present disclosure;

FIG. 4 shows a second embodiment of the support structure of a display panel according to the present disclosure; and

FIG. 5 shows a third embodiment of the support structure of a display panel according to the present disclosure.

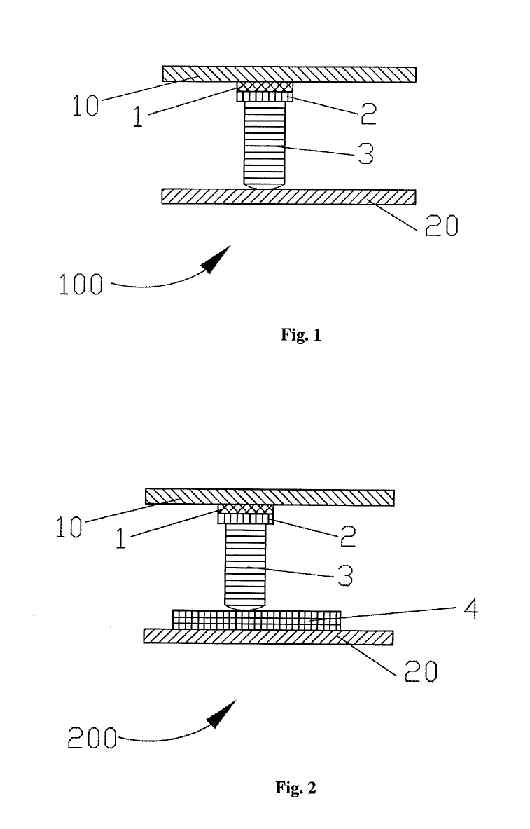

In the drawings, the same components are indicated with the same reference signs. The figures are not drawn in accordance with an actual scale.

### DETAILED DESCRIPTION OF THE EMBODIMENTS

In the following, the present disclosure will be further explained in connection with the accompanying drawings.

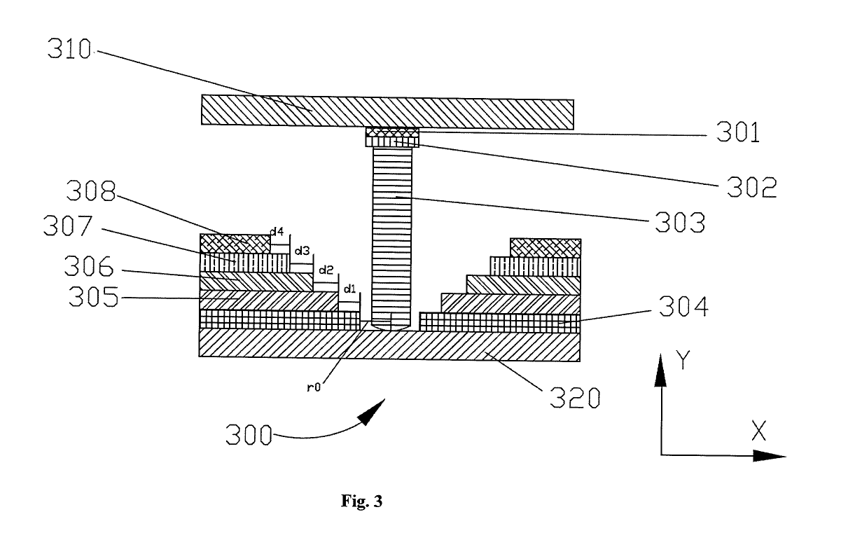

FIG. 3 shows a first embodiment of a support structure of a display panel according to the present disclosure.

In the embodiment as shown in FIG. 3, a support structure 300 of a display panel comprises an array substrate and a color filter substrate.

The array substrate includes a lower plate glass 320, and five functional layers on a side of the lower plate glass 302 facing the color filter substrate. In the embodiment as shown in FIG. 3, the functional layers comprise, from the bottom up, a first metal layer 304 adjacent to the lower plate glass 320, a first insulation layer 305 adjacent to the first metal layer 304, a second metal layer 306 adjacent to the first insulation layer 305, a second insulation layer 307 adjacent to the second metal layer 306, and a pixel electrode layer 308 adjacent to the second insulation layer 307, respectively.

The color filter substrate has an upper plate glass 310, and a black matrix 301 and a common electrode layer 302 that are located on a side of the upper plate glass 310 facing the array substrate 320.

A photo spacer 303 is arranged between the array substrate and the color filter substrate and extends along a Y-direction, for maintaining a distance between the array substrate and the color filter substrate. The Y-direction shows a normal direction of the display panel, and is the same direction as indicated by a Y-axis in a coordinate system located at a bottom right corner of FIG. 3, i.e., the vertical direction of FIG. 3.

A first end portion of the photo spacer 303 is fixed to the color filter substrate. The first end portion constitutes an upper end portion as illustrated in FIG. 3. In the embodiment as shown in FIG. 3, the first end portion of the photo spacer 303 is fixed to the common electrode layer 302 on a surface thereof facing the array substrate.

However, those skilled in the art can understand that this is not definitely so as described above. As a specific configuration requires, different connecting structures can be provided between the photo spacer 303 and the color filter substrate at the first end portion of the photo spacer 303.

In one alternative embodiment, the first end portion of the photo spacer 303 can also be directly fixed to the upper plate glass 310 on a surface thereof facing the array substrate. In another alternative embodiment, the first end portion of the photo spacer 303 can also be fixed to the black matrix 301 on a surface thereof facing the array substrate.

As can be explicitly conceived from FIG. 3, each of the first metal layer 304, the first insulation layer 305, the second metal layer 306, the second insulation layer 307, and the pixel electrode layer 308 of the array substrate has an opening. In addition, viewed from the Y-direction, i.e., the same direction as indicated by the Y-axis in the coordinate system located at the bottom right corner of FIG. 3, or the vertical direction of FIG. 3, the openings of different functional layers at least partially overlap with each other to jointly form a recess through which the photo spacer 303 can pass. The recess is tapered toward the lower plate glass in size along an X-direction, i.e., a direction as indicated by an X-axis in the coordinate system located at the bottom right corner of FIG. 3, or the lateral direction of FIG. 3. Meanwhile, the X-direction is in the plane where the display panel is located also.

As FIG. 3 explicitly shows, the photo spacer 303 passes through the recess formed by the openings of first metal layer 304, the first insulation layer 305, the second metal layer 306, the second insulation layer 307, and the pixel electrode layer 308, to abut against the lower plate glass 320 at a second end portion thereof. FIG. 3 shows that the second end portion constitutes a lower end of the photo spacer 303.

Preferably, the distance from an edge of the opening of the first metal layer 304 to an outer circumferential surface of the photo spacer 303 is in the range from 0 μm to 10 μm. Such arrangement of the size of the stepped structure enables an optimal effect in preventing dislocation of the photo spacer. Since the distance from the edge of the opening of the first metal layer 304 to the outer circumferential surface of the photo spacer would predominately influence the size of the recess, the photo spacer can be restored to its original position in an automatic and rapid manner under the function of a gradient of the recess if a dislocation occurs, when the above size range is satisfied.

Further preferably, the sizes of the openings of the pixel electrode layer 308, the second insulation layer 307, the second metal layer 306, the first insulation layer 305, and the first metal layer 304 in the X-direction are reduced gradually along a direction toward the lower plate glass 302.

Preferably, a difference between the distance from an edge of the opening of a functional layer to the outer circumferential surface of the photo spacer 303 and the distance from an edge of the opening of an adjacent functional layer to said outer circumferential surface of the photo spacer is in the range from 0.5 μm to 10 μm. In this manner, all the functional layers of the array substrate can be adequately used for preventing dislocation. Moreover, the stepped side wall of the recess that has been formed is continuously tapered in size, thus enabling an optimal effect in preventing the photo spacer from being dislocated.

Specifically, with reference to the embodiment as shown in FIG. 3, d1 represents a difference between the distance from the edge of the opening of the first metal layer 304 to the outer circumferential surface of the photo spacer 303 and the distance from the edge of the opening of the first insulation layer 305 to the outer circumferential surface of the photo spacer 303. Preferably, d1 ranges from 0.5 μm to 10 μm.

d2 represents a difference between the distance from the edge of the opening of the first insulation layer 305 to the outer circumferential surface of the photo spacer 303 and the distance from the edge of the opening of the second metal layer 306 to the outer circumferential surface of the photo spacer 303. Preferably, d2 ranges from 0.5 μm to 10 μm.

d3 represents a difference between the distance from the edge of the opening of the second metal layer 306 to the outer circumferential surface of the photo spacer 303 and the distance from the edge of the opening of the second insulation layer 307 to the outer circumferential surface of the photo spacer 303. Preferably, d3 ranges from 0.5 μm to 10 μm.

d4 represents a difference between the distance from the edge of the opening of the second insulation layer 307 to the outer circumferential surface of the photo spacer 303 and the distance from the edge of the opening of the pixel electrode layer 308 to the outer circumferential surface of the photo spacer 303. Preferably, d4 ranges from 0.5 μm to 10 μm.

In the support structure 300, the photo spacer 303 can be restored to its original position at a bottom of a slope within a radius R which equals r0+d1+d2+d3+d4, wherein r0 represents the distance from the edge of the opening of the first metal layer 304 to a center of an bottom side of the photo spacer 303. The above preferred size ranges would enable the radius R, within which the photo spacer 303 can be restored, to comply with a common order of dislocation of the photo spacer 303.

In one alternative embodiment, an array substrate manufactured through a five mask procedure can be arranged with an amorphous silicon layer between the second metal layer and the first insulation layer, so as to form a stepped recess having six steps.

That is, the array substrate comprises six functional layers, respectively as the first metal layer adjacent to the lower plate glass 302, the first insulation layer adjacent to the first metal layer, the amorphous silicon layer adjacent to the first insulation layer, a second metal layer adjacent to the amorphous silicon layer, the second insulation layer adjacent to the second metal layer, and the pixel electrode layer adjacent to the second insulation layer, wherein each of the six functional layer has an opening, and the second end portion of the photo spacer abuts against the lower plate glass 320.

This technical solution can be particularly used in an array substrate manufactured through a five mask procedure, which is commonly adopted in the manufacturing procedure of a display panel. Hence, in combination with the support structure according to the present disclosure, costs of large-scale manufacture can be beneficially reduced.

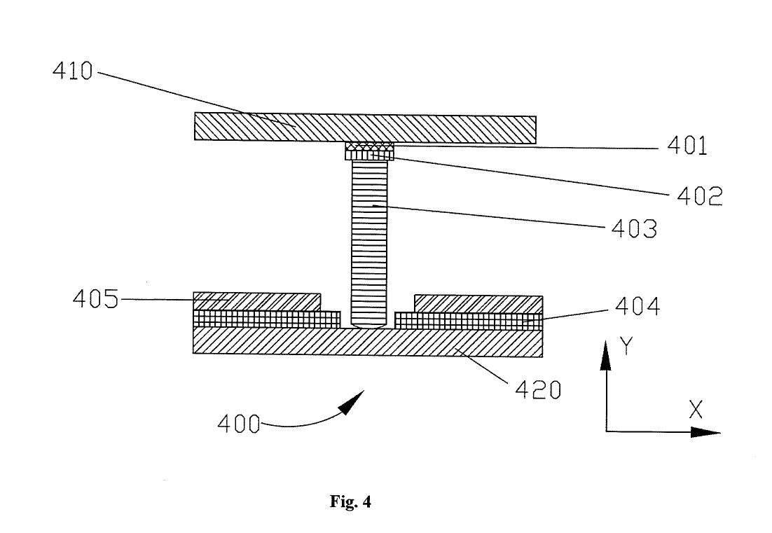

FIG. 4 shows a second embodiment of the support structure of a display panel according to the present disclosure.

In the embodiment as shown in FIG. 4, a support structure 400 of a display panel comprises an array substrate and a color filter substrate.

The array substrate includes a lower plate glass 420, and two functional layers on a side of the lower plate glass 420 facing the color filter substrate. In the embodiment as shown in FIG. 4, the functional layers comprise, from the bottom up, a first metal layer 404 adjacent to the lower plate glass 420 and a first insulation layer 405 adjacent to the first metal layer 404, respectively.

The color filter substrate has an upper plate glass 410, and a black matrix 401 and a common electrode layer 402 that are located on a side of the upper plate glass 410 facing the array substrate 420.

A photo spacer 403 is arranged between the array substrate and the color filter substrate and extends along a Y-direction, for maintaining a distance between the array substrate and the color filter substrate. The Y-direction shows a normal direction of the display panel, and is the same direction as indicated by a Y-axis in a coordinate system located at a bottom right corner of FIG. 4, i.e., the vertical direction of FIG. 4.

A first end portion of the photo spacer 403 is fixed to the color filter substrate. The first end portion constitutes an upper end portion as illustrated in FIG. 4. In the embodiment as shown in FIG. 4, the first end portion of the photo spacer 403 is fixed to the common electrode layer 402 on a surface thereof facing the array substrate.

However, those skilled in the art can understand that this is not definitely so as described above. As a specific configuration requires, different connecting structures can be provided between the photo spacer 403 and the color filter substrate at the first end portion of the photo spacer 403.

In one alternative embodiment, the first end portion of the photo spacer 403 can also be directly fixed to the upper plate glass 410 on a surface thereof facing the array substrate. In another alternative embodiment, the first end portion of the photo spacer 403 can also be fixed to the black matrix 401 on a surface thereof facing the array substrate.

As can be explicitly conceived from FIG. 4, each of the first metal layer 404 and the first insulation layer 405 of the array substrate has an opening. In addition, viewed from the Y-direction, i.e., the direction as indicated by the Y-axis in the coordinate system located at the bottom right corner of FIG. 4, or the vertical direction of FIG. 4, the openings of different functional layers at least partially overlap with each other to jointly form a recess through which the photo spacer 403 can pass. The recess is tapered toward the lower plate glass in size along an X-direction, i.e., a direction as indicated by an X-axis in the coordinate system located at the bottom right corner of FIG. 4, or the lateral direction of FIG. 4. Meanwhile, the X-direction is also in the plane where the display panel is located.

As FIG. 4 explicitly shows, the photo spacer 403 passes through the recess formed by the openings of the first metal layer 404 and the first insulation layer 405 to abut against the lower plate glass 420 at a second end portion thereof. FIG. 4 shows that the second end portion constitutes a lower end of the photo spacer 403.

Meanwhile, the opening of the first insulation layer 405 is smaller than that of the first metal layer 404 in size along the X-direction.

Preferably, the distance from an edge of the opening of the first metal layer 404 to an outer circumferential surface of the photo spacer 403 is in the range from 0 μm to 10 μm. Preferably, a difference between the distance from an edge of the opening of a functional layer to the outer circumferential surface of the photo spacer 403 and the distance from an edge of the opening of an adjacent functional layer to said outer circumferential surface of the photo spacer is in the range from 0.5 μm to 10 μm.

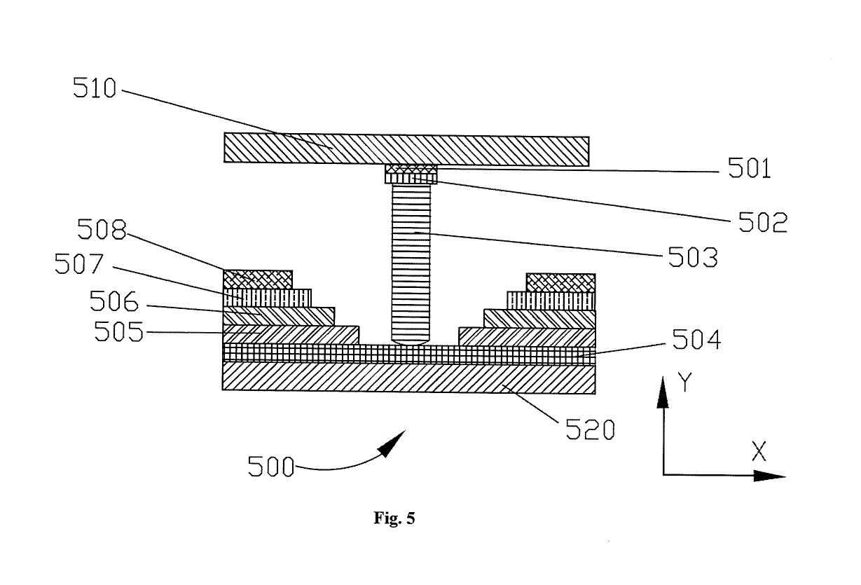

FIG. 5 shows a third embodiment of the support structure of a display panel according to the present disclosure.

In the embodiment as shown in FIG. 5, a support structure 500 of a display panel comprises an array substrate and a color filter substrate.

The array substrate includes a lower plate glass 520, and five functional layers on a side of the lower plate glass 520 facing the color filter substrate. In the embodiment as shown in FIG. 5, the functional layers comprise, from the bottom up, a first metal layer 504 adjacent to the lower plate glass 520, a first insulation layer 505 adjacent to the first metal layer 504, a second metal layer 506 adjacent to the first insulation layer 505, a second insulation layer 507 adjacent to the second metal layer 506, and a pixel electrode layer 508 adjacent to the second insulation layer 507, respectively.

The color filter substrate has an upper plate glass 510, and a black matrix 501 and a common electrode layer 502 that are located on a side of the upper plate glass 510 facing the array substrate 520.

A photo spacer 503 is arranged between the array substrate and the color filter substrate and extends along a Y-direction, for maintaining a distance between the array substrate and the color filter substrate. The Y-direction shows a normal direction of the display panel, and is the same direction as indicated by a Y-axis in a coordinate system located at a bottom right corner of FIG. 5, i.e., the vertical direction of FIG. 5.

A first end portion of the photo spacer 503 is fixed to the color filter substrate. The first end portion constitutes an upper end portion as illustrated in FIG. 5. In the embodiment as shown in FIG. 5, the first end portion of the photo spacer 503 is fixed to the common electrode layer 502 on a surface thereof facing the array substrate.

However, those skilled in the art can understand that this is not definitely so as described above. As a specific configuration requires, different connecting structures can be provided between the photo spacer 503 and the color filter substrate at the first end portion of the photo spacer 503.

In one alternative embodiment, the first end portion of the photo spacer 503 can also be directly fixed to the upper plate glass 510 on a surface thereof facing the array substrate. In another alternative embodiment, the first end portion of the photo spacer 503 can also be fixed to the black matrix 501 on a surface thereof facing the array substrate.

As can be explicitly conceived from FIG. 5, the first metal layer 504 of the array substrate has no opening, while each of the first insulation layer 505, the second metal layer 506, the second insulation layer 507, and the pixel electrode layer 508 of the array substrate has an opening. In addition, viewed from the Y-direction, i.e., the direction as indicated by the Y-axis in the coordinate system located at the bottom right corner of FIG. 5, or the vertical direction of FIG. 5, the openings of different functional layers at least partially overlap with each other to jointly form a recess through which the photo spacer 503 can pass. The recess is tapered toward the lower plate glass 520 in size along an X-direction, i.e. the direction as indicated by an X-axis in the coordinate system located at the bottom right corner of FIG. 5, or the lateral direction of FIG. 5. Meanwhile, the X-direction is also in the plane where the display panel is located.

As FIG. 5 explicitly shows, the photo spacer 503 passes through the recess formed by the pixel electrode layer 508, the second insulation layer 507, the second metal layer 506, and the first insulation layer 505, to abut against the first metal layer 504 at a second end portion thereof. FIG. 5 shows that the second end portion constitutes a lower end of the photo spacer 503.

The present disclosure further discloses a display panel comprising the support structure of the present disclosure.

Compared with the prior art, the support structure of a display panel and the corresponding display panel according to the present disclosure can remove the technical defects in the prior art and bring about new advantages.

At the outset, according to the support structure of a display panel of the present disclosure, a recess through which the photo spacer passes is formed on the array substrate. Such being the case, a side wall of the recess would prevent slide of the photo spacer along the X-direction, thereby fixing the photo spacer in the plane where the panel is located. As can be seen, the recess functions as limiting the color filter substrate and the array substrate with respect to each other, to avoid dislocation therebetween in the plane where the panel is located. As a result, the problems of light leakage from the panel, inhomogeneous display colors, and image interference, etc. caused thereby can be avoided, thus improving the quality of the panel. Such improvement is impossible in the prior art.

Moreover, at least a part of the recess is tapered toward the lower plate glass in size along the X-direction. In this manner, a stepped side wall having a plurality of steps can be formed in the recess. Thus, a dislocated photo spacer would slide back to its original position along the side wall under the effect of gravity. That is, the photo spacer can be restored to its original position automatically.

In addition, the stepwise tapered recess can be formed by a plurality of functional layers of the array substrate through a rather simple procedure. No additional component, clad layer, or coating layer is required. Instead, the functional layers that have already been arranged in the array substrate are ingeniously used. Hence, the above two additional effects can be achieved without increasing complexity of the procedure or sizes of a product.

Although the present disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims. It will be appreciated that the various dependent claims and the features set forth therein can be combined in different ways than presented in the initial claims. It will also be appreciated that the features described in connection with individual embodiments may be shared with others of the described embodiments.

1. A support structure of a display panel, comprising an array substrate, a color filter substrate, and a photo spacer that is arranged between the array substrate and the color filter substrate and extends along a first direction, for maintaining a distance between the array substrate and the color filter substrate,
wherein the array substrate has a lower plate glass with at least two functional layers at a side of the lower plate glass facing the color filter substrate, the at least two functional layers of the array substrate having openings, which, viewed from the first direction, at least partially overlap with each other to jointly constitute a recess through which the photo spacer passes, at least a part of the recess being tapered toward the lower plate glass in size along a second direction,
wherein the photo spacer has a first end portion fixed to the color filter substrate, and passes through the recess to abut against the lower plate glass or against one of the functional layers at a second end portion of the photo spacer, and
wherein the first direction constitutes a normal direction of the display panel, and the second direction is in the plane where the display panel is located.

2. The support structure according to claim 1, wherein the sizes of the openings of the different functional layers of the array substrate in the second direction are reduced along a direction toward the lower plate glass gradually.

3. The support structure according to claim 2, wherein a difference between the distance from an edge of the opening of a functional layer to an outer circumferential surface of the photo spacer and the distance from an edge of the opening of an adjacent functional layer to said outer circumferential surface of the photo spacer is in the range from 0.5 μm to 10 μm.

4. The support structure according to claim 1, wherein the array substrate comprises five functional layers, respectively as a first metal layer adjacent to the lower plate glass, a first insulation layer adjacent to the first metal layer, a second metal layer adjacent to the first insulation layer, a second insulation layer adjacent to the second metal layer, and a pixel electrode layer adjacent to the second insulation layer, wherein each of the five functional layers has an opening, and the second end portion of the photo spacer abuts against the lower plate glass.

5. The support structure according to claim 4, wherein the distance from an edge of the opening of the first metal layer to the outer circumferential surface of the photo spacer is in the range from 0 μm to 10 μm.

6. The support structure according to claim 2, wherein the array substrate comprises five functional layers respectively as a first metal layer adjacent to the lower plate glass, a first insulation layer adjacent to the first metal layer, a second metal layer adjacent to the first insulation layer, a second insulation layer adjacent to the second metal layer, and a pixel electrode layer adjacent to the second insulation layer, wherein each of the five functional layers has an opening, and the second end portion of the photo spacer abuts against the lower plate glass.

7. The support structure according to claim 1, wherein the array substrate comprises six functional layers, respectively as a first metal layer adjacent to the lower plate glass, a first insulation layer adjacent to the first metal layer, an amorphous silicon layer adjacent to the first insulation layer, a second metal layer adjacent to the amorphous silicon layer, a second insulation layer adjacent to the second metal layer, and a pixel electrode layer adjacent to the second insulation layer, wherein each of the six functional layers has an opening, and the second end portion of the photo spacer abuts against the lower plate glass.

8. The support structure according to claim 7, wherein the distance from an edge of the opening of the first metal layer to the outer circumferential surface of the photo spacer is in the range from 0 μm to 10 μm.

9. The support structure according to claim 2, wherein the array substrate comprises six functional layers, respectively as a first metal layer adjacent to the lower plate glass, a first insulation layer adjacent to the first metal layer, an amorphous silicon layer adjacent to the first insulation layer, a second metal layer adjacent to the amorphous silicon layer, a second insulation layer adjacent to the second metal layer, and a pixel electrode layer adjacent to the second insulation layer, wherein each of the six functional layers has an opening, and the second end portion of the photo spacer abuts against the lower plate glass.

10. The support structure according to claim 1, wherein the array substrate comprises two functional layers, respectively as a first metal layer adjacent to the lower plate glass and a first insulation layer adjacent to the first metal layer, and each of the two functional layers has an opening.

11. The support structure according to claim 2, wherein the array substrate comprises two functional layers, respectively as a first metal layer adjacent to the lower plate glass and a first insulation layer adjacent to the first metal layer, and each of the two functional layers has an opening.

12. The support structure according to claim 3, wherein the array substrate comprises two functional layers, respectively as a first metal layer adjacent to the lower plate glass and a first insulation layer adjacent to the first metal layer, and each of the two functional layers has an opening.

13. The support structure according to claim 1, wherein the array substrate comprises:
a first metal layer adjacent to the lower plate glass, the first metal layer having no opening, and
four functional layers, respectively as a first insulation layer adjacent to the first metal layer, a second metal layer adjacent to the first insulation layer, a second insulation layer adjacent to the second metal layer, and a pixel electrode layer adjacent to the second insulation layer,
wherein each of said four functional layers has an opening, and the second end portion of the photo spacer abuts against the first metal layer.

14. The support structure according to claim 2, wherein the array substrate comprises:
a first metal layer adjacent to the lower plate glass, the first metal layer having no opening, and
four functional layers, respectively as a first insulation layer adjacent to the first metal layer, a second metal layer adjacent to the first insulation layer, a second insulation layer adjacent to the second metal layer, and a pixel electrode layer adjacent to the second insulation layer,
wherein each of said four functional layers has an opening, and the second end portion of the photo spacer abuts against the first metal layer.

15. The support structure according to claim 3, wherein the array substrate comprises:
a first metal layer adjacent to the lower plate glass, the first metal layer having no opening, and
four functional layers, respectively as a first insulation layer adjacent to the first metal layer, a second metal layer adjacent to the first insulation layer, a second insulation layer adjacent to the second metal layer, and a pixel electrode layer adjacent to the second insulation layer,
wherein each of said four functional layers has an opening, and the second end portion of the photo spacer abuts against the first metal layer.

16. The support structure according to claim 1, wherein the color filter substrate has an upper plate glass, and a black matrix and a common electrode that are both located on the upper plate glass on a side thereof facing the array substrate, and
wherein the first end portion of the photo spacer is fixed to the upper plate glass on a surface thereof facing the array substrate, or to the black matrix on a surface thereof facing the array substrate, or to the common electrode layer on a surface thereof facing the array substrate.

17. A display panel comprising a support structure,
wherein the support structure includes an array substrate, a color filter substrate, and a photo spacer that is arranged between the array substrate and the color filter substrate and extends along a first direction, for maintaining a distance between the array substrate and the color filter substrate,
wherein the array substrate has a lower plate glass with at least two functional layers at a side of the lower plate glass facing the color filter substrate, the at least two functional layers of the array substrate having openings, which, viewed from the first direction, at least partially overlap with each other to jointly constitute a recess through which the photo spacer passes, at least a part of the recess being tapered toward the lower plate glass in size along a second direction,
wherein the photo spacer has a first end portion fixed to the color filter substrate, and passes through the recess to abut against the lower plate glass or against one of the functional layers at a second end portion of the photo spacer, and
wherein the first direction constitutes a normal direction of the display panel, and the second direction is in the plane where the display panel is located.
